(19) United States
(12) Patent Application Publication
(10) Pub. No.: US 2013/0201126 A1
(43) Pub. Date: Aug. 8, 2013

(54) INPUT DEVICE

(71) Applicant: DENSO CORPORATION, Kariya-city (JP)

(72) Inventor: Hiroyuki Mimura, Kariya-city (JP)

(73) Assignee: DENSO CORPORATION, Kariya-city (JP)

(21) Appl. No.: 13/740,569

(22) Filed: Jan. 14, 2013

(30) Foreign Application Priority Data
Feb. 3, 2012 (JP) 2012-22167

(51) Int. Cl. G06F 3/0488

(52) U.S. Cl. CPC G06F 3/0488
USPC 345/173

(57) ABSTRACT

An input device includes an input unit, which is a separate component from a display unit. The input unit includes a first operable region and a second operable region partitioned from each other. The first operable region accepts an input operation with a first finger of a user for indicating information on the display unit. The second operable region accepts an input operation with a second finger, which is different from the first finger, for indicating information on the display unit. A display control unit modifies indication of the information correspondingly to an input operation with the first finger in the first operable region and an input operation with the second finger in the second operable region.

### CROSS REFERENCE TO RELATED APPLICATION

This application is based on reference Japanese Patent Application No. 2012-22167 filed on Feb. 3, 2012, the disclosure of which is incorporated herein by reference.

### TECHNICAL FIELD

The present disclosure relates to an input device configured to accept a finger operation for indicting information.

### BACKGROUND

For example, JP-A-2009-522669, which corresponds to Publication of US Patent Application No. 2007-0152984, discloses a conventional portable electronic device configured to accept a multi-touch input operation. The portable electronic device of JP-A-2009-522669 has a window (display unit) indicating a graphic object and accepts both a pinch-in operation by using two fingers to contract the graphic object and a pinch-out operation by using two fingers to enlarge the graphic object.

It is noted that, in the portable electronic device of the JP-A-2009-522669, in a case where a user cannot use two fingers freely, the user would feel much burden and difficulty to enlarge or to reduce a graphic object using the two fingers.

### SUMMARY

It is an object of the present disclosure to produce an input device configured to enable an input operation even when operation with two fingers of a user is restricted.

According to an aspect of the present disclosure, an input device comprises an input unit being a separate component from a display unit, the input unit being configured to accept an input operation with a finger of a user for manipulating information indicated on the display unit, the input unit including a first operable region and a second operable region, which are partitioned from each other, the first operable region being configured to accept an input operation with a first finger, the second operable region being configured to accept an input operation with a second finger, which is different from the first finger. The input device further comprises a display control unit configured to modify indication of information correspondingly to an input operation with the first finger in the first operable region and an input operation with the second finger in the second operable region.

According to another aspect of the present disclosure, an input device for manipulating indication of information on a display unit, the input device comprises an input unit being a separate component from the display unit, the input unit including a first operable region and a second operable region, which are partitioned from each other, the first operable region being configured to accept an input operation with at least one of a first finger and a second finger of a user, the second operable region being configured to accept an input operation with one of the first finger and the second finger. The input device further comprises a determination unit configured to determine whether the first operable region accepts an input operation and to determine whether the second operable region accepts an input operation. The input device further comprises an indication control unit configured to modify indication of information in a first mode when the determination unit determines that the first operable region accepts an input operation and to modify indication of information in a second mode, which is different from the first mode, when the determination unit determines that the second operable region accepts an input operation.

According to another aspect of the present disclosure, an input device for manipulating indication of information on a display unit, the input device comprises an input unit being a separate component from the display unit, the input unit including a first operable region and a second operable region, which are partitioned from each other, the first operable region being configured to accept an input operation with both a first finger and a second finger of a user, the second operable region being configured to accept an input operation with one of the first finger and the second finger. The input device further comprises a determination unit configured to determine whether the first operable region accepts an input operation and to determine whether the second operable region accepts an input operation. The input device further comprises an indication control unit configured to modify indication of information in a first mode when the determination unit determines that the first operable region accepts an input operation and to modify indication of information in a second mode, which is different from the first mode, when the determination unit determines that the second operable region accepts an input operation.

These configurations enable a user to operate the input device with the one of the first finger and the second finger in the second operable region when the user is restricted from operating in the first operable region with, for example, both the first finger and the second finger.

### BRIEF DESCRIPTION OF THE DRAWINGS

The above and other objects, features and advantages of the present invention will become more apparent from the following detailed description made with reference to the accompanying drawings. In the drawings:

FIG. 1 is a configuration diagram showing a navigation system;

FIG. 2 is a schematic view showing a display device and an input unit according to a first embodiment;

FIG. 3 is a flowchart showing contents of a control implemented by a control unit, according to the first embodiment;

FIG. 4 is a schematic view showing an operation for an enlarging indication according to the first embodiment;

FIG. 5 is a schematic view showing an operation for a contracting indication according to the first embodiment;

FIG. 6 is a schematic view showing an input unit according to a second embodiment; and

FIG. 7 is a schematic view showing an input unit according to a third embodiment.

### DETAILED DESCRIPTION

As follows, embodiments will be described with reference to drawings. In the embodiments, an element described in a subsequent embodiment may be denoted by the same reference numeral, and description of such an element may be omitted. When only a part of a structure of an element is described in an embodiment, other part of the structure of the element may be equivalent to that of another foregoing embodiment. Combinations of elements are not limited to those specified in an embodiment. As long as a combination does not cause a defect, various combinations of elements and embodiments may be arbitrary made.

### First Embodiment

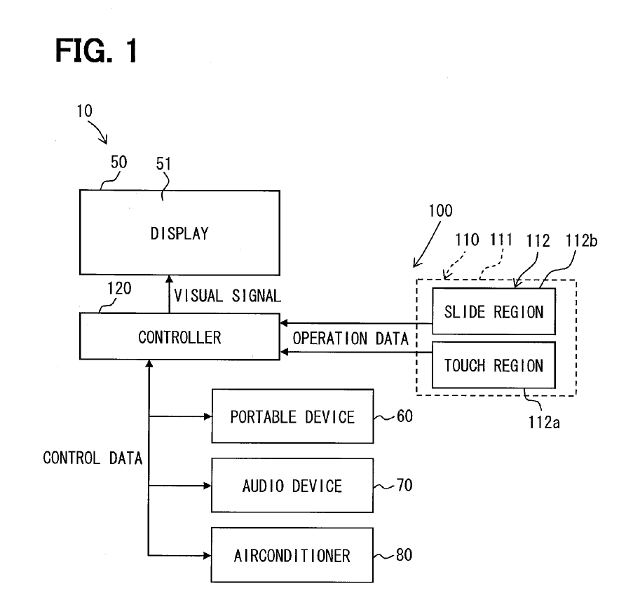

As follows, an input device 100 according to the first embodiment will be described with reference to FIG. 1 to FIG. 5. In the present embodiment, the input device 100 is employed in a navigation system 10 for a vehicle.

The navigation system 10 is a route guidance system and includes a display device (display unit) 50 for indicating a map, a present position of a self-vehicle on the map, a traveling direction of the self-vehicle, guidance information toward a desired destination, and the like. As shown in FIG. 1, the navigation system 10 includes the display device 50 and the input device 100. The input device 100 includes an input unit 110 and a display control unit 120. The display device 50 and the input device 100 are connected with each other via, for example, a communication unit and/or a signal line.

The navigation system 10 is configured to cooperate with, for example, a multifunctional portable device 60, an audio device 70, an airconditioner 80, and the like. The navigation system 10 enables operation of these devices 60, 70, and 80 via the Input device 100. The multifunctional portable device 60 is connected with, for example, the display control unit 120 by wire or by wireless when carried into the interior of the self-vehicle by a driver (user). Thus, functions of the multifunctional portable device 60 become partially or entirely operational with an input operation via the input unit 110. In addition, the display device 50 is enabled to indicate various information obtained by the multifunctional portable device 60. The audio device 70 is connected with the display control unit 120. The audio device 70 is configured to accept an input operation via the input unit 110 and is configured, for example, to select and playback multiple music data prestored in the storage unit, playback an audio CD, tuning in a radio station, and/or the like, in response to the input operation. The airconditioner 80 is connected with the display control unit 120 and is configured, for example, to select a set temperature, a quantity of airflow, a blow-off mode of air, and/or the like, in response to an input operation via the input unit 110.

The display device 50 includes an indication screen 51 configured to indicate information selected from multiple categories. The display device 50 is located at, for example, a position where a driver can easily view. More specifically, the display device 50 may be located at, for example, a center and upper position in an instrument panel. The display device 50 may include a liquid crystal display panel, an organic EL display panel, and/or the like. The display device 50 is configured to indicate various information, such as map information related to path guidance toward the destination, information on the self-vehicle position, information for searching the destination, information related to voice guidance and text guidance, and/or the like. The display device 50 may be further configured to indicate information related to operations related to the devices 60, 70, and 80, and/or the like. The indication screen 51 is configured to indicate various information items, such as buttons, corresponding to information items, respectively. The indication screen 51 is further configured to enable a driver to select one of the information items and to enter the selected one item, thereby to browse screens successively and to access a desired information screen indicating desired information. In the present embodiment, a driver is enabled to manipulate, as basic operation, a touch operable region 112a in the input unit 110 thereby to browse desirable information on the display device 50. A driver is further enabled to manipulate a slide operable region 112b thereby to implement an enlarging indication of information indicated on the indication screen 51 or to implement a contracting indication of information indicated on the indication screen 51.

The input device 100 includes the input unit 110 and the display control unit 120. The input unit 110 is configured to accept an input operation implemented by a driver to indicate desirable information on the indication screen 51. The input unit 110 is, for example, equipped close to a shift lever located between a driver's seat and a passenger's seat. The input unit 110 includes a body portion 111, which is, for example, a flat case. The body portion 111 has an upper surface 111a on which a touchpad 112 is formed. A driver is enabled to touch the surface of the input unit (touchpad) 110 with a fingertip thereby to implement an input operation for indicating information.

The touchpad 112 includes, for example, an electrostatic sensor. The touchpad 112 is configured to recognize change in capacitance between a fingertip of a driver and the electrostatic sensor thereby to accept an operation caused by the finger of the driver. The touchpad 112 is further configured to generate a predetermined signal according to a locus, on which the finger moves on the surface of the touchpad 112, the position of the finger when the finger stops moving on the touchpad 112, and/or the like. The touchpad 112 is further configured to send the predetermined signal generated by the operation (finger operation) of the finger to the display control unit 120. The finger operation may include, for example, a slide operation and a tap operation. The slide operation is implemented by sliding a fingertip on the surface of the touchpad 112. The tap operation is implemented by touching a fingertip lightly on the surface of the touchpad 112. The touchpad 112 is not limited to include the electrostatic sensor and may include a pressure-sensitive sensor, instead of or in addition to the electrostatic sensor.

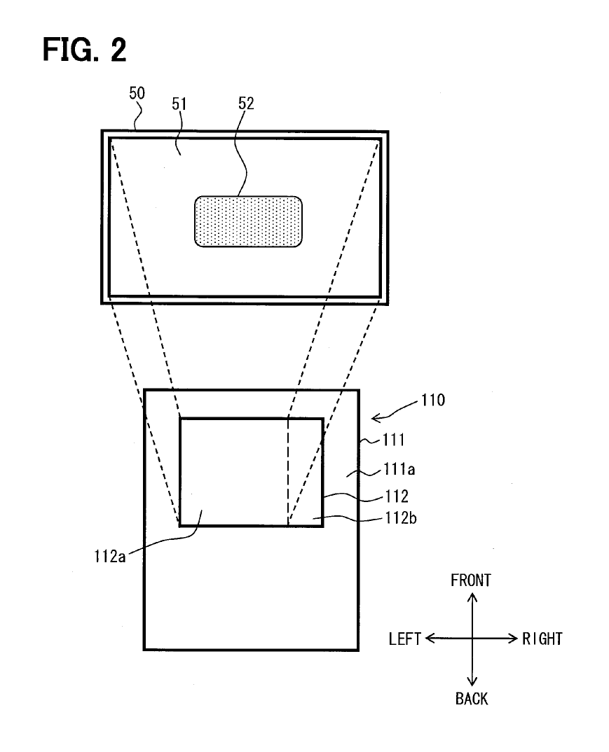

The touchpad 112 includes the touch operable region 112a and the slide operable region 112b for accepting an input operation of a driver. The touch operable region 112a may be equivalent to a first operable region of the present disclosure, and the slide operable region 112b may be equivalent to a second operable region of the present disclosure. As shown in FIG. 2, the touch operable region 112a and the slide operable region 112b are formed on the upper surface 111a of the body portion 111 and are adjacent to each other in the horizontal direction of the vehicle. The touch operable region 112a is located on the left side of the touchpad 112. The touch operable region 112a occupies most of the touchpad 112. The slide operable region 112b is smaller than the touch operable region 112a and is located on the right side of the touchpad 112. The slide operable region 112b is a strip-shaped region extending in the front-back direction of the vehicle. That is, the slide operable region 112b extends along the right side of the touchpad 112.

The touch operable region 112a is configured to enable a driver to implement basic input operations on the display device 50 by accepting finger operations, such as the slide operation and/or the tap operation among of the driver. More specifically, the touch operable region 112a is configured to accept an operation to indicate, on the indication screen 51, various information, such as an indicated object including, for example, a map 52, when the navigation system 10 is in operation and/or information related to the devices 60, 70, and 80 when the driver uses the devices 60, 70, and 80.

The slide operable region 112b is for an exclusive use to enable a driver to implement an input operation different from the input operation on the touch operable region 112a. Specifically, the slide operable region 112b is used for implementing the enlarging indication and/or the contracting indication of information (indicated information) such as the map 52 indicated on the indication screen 51. For example, an input operation for enlarging indicated information is implemented by sliding one finger on the slide operable region 112b forward in a predetermined direction. Alternatively, an input operation for contracting indicated information is implemented by, for example, sliding one finger on the slide operable region 112b backward in another direction different from the predetermined direction.

In the present configuration, the indicated content on the indication screen 51 when the input operation is implemented on the touch operable region 112a differs from the indicated content on the indication screen 51 when the input operation is implemented on the slide operable region 112b.

The display control unit 120 is configured to control an indication state of information indicated on the indication screen 51 and required when the navigation system 10 is in operation or required when a driver uses the devices 60, 70, and 80. Specifically, the display control unit 120 is configured to switch indicated information and/or enlarge or contract the indicated information on request by a driver, according to a finger operation of the driver on the touch operable region 112a and/or the slide operable region 112b of the touchpad 112.

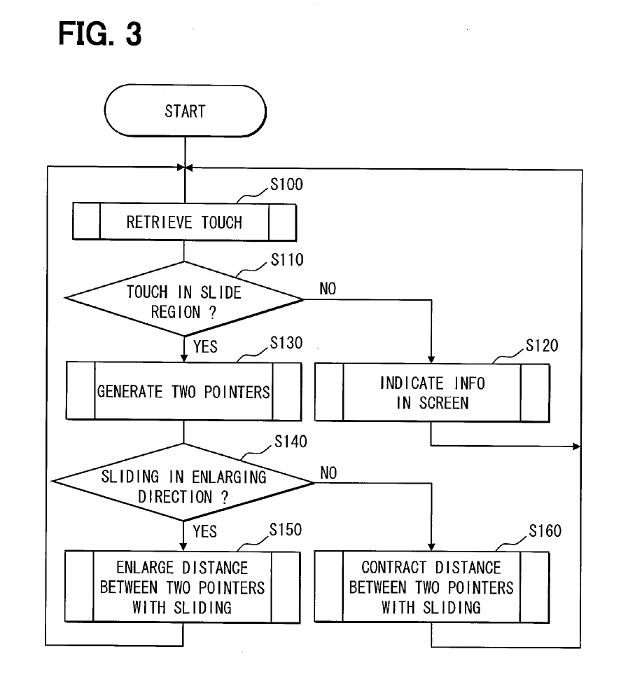

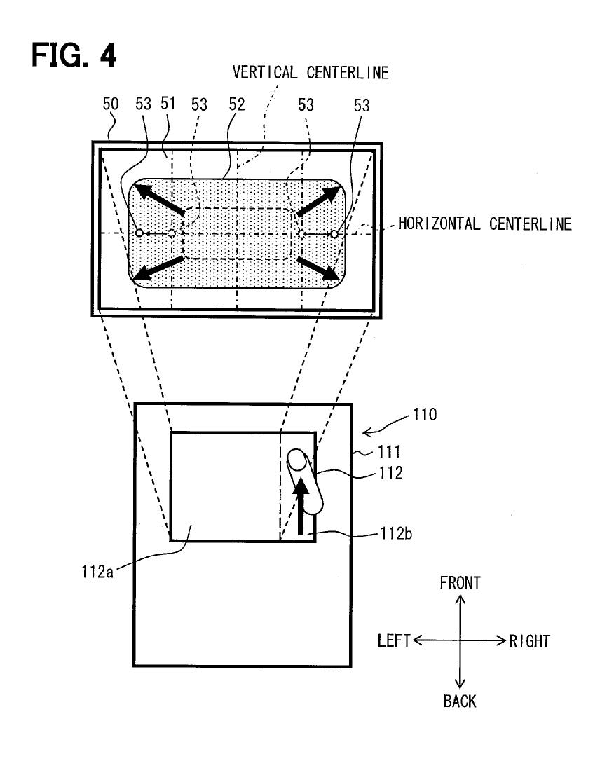

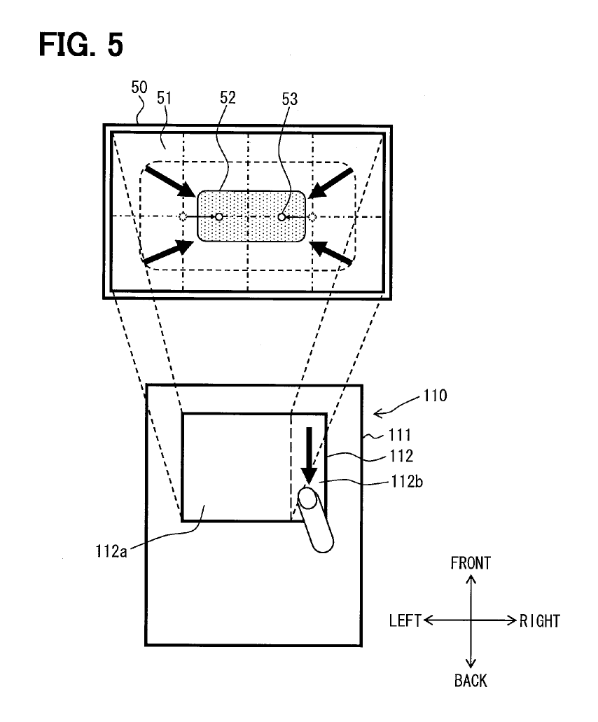

Subsequently, an operation of the navigation system 10 will be described with reference to the flowchart shown in FIG. 3 and the schematic views shown in FIGS. 4 and 5.

At step S100, the display control unit 120 retrieves a signal generated by a touch operation implemented on the touchpad 112 by a driver. At step S110, the display control unit 120 determines whether the retrieved signal of the touch operation is from the slide operable region 112b, not from the touch operable region 112a. When the display control unit 120 makes a negative determination, i.e., when determining that the retrieved signal is from the touch operable region 112a, the processing proceeds to step S120.

At step S120, the display control unit 120 moves a cursor on the indication screen 51, according to the slide operation of the driver, thereby to cause an information item, which is desired by the driver, to be in a selected state. When the information item being in the selected state is tapped by the driver, the display control unit 120 further causes the tapped information item to be in a determined state. Subsequently, the display control unit 120 further indicates a desired information screen successively thereby to provide information desired by the driver.

Alternatively, at step S110, when the display control unit 120 makes a positive determination, i.e., when determining that the retrieved signal of the touch operation is from the slide operable region 112b, the processing proceeds to step S130 to implement the enlarging indication and/or the contracting indication of the indicated information.

At step S130, the display control unit 120 first generates two pointers 53 on the indication screen 51. The two pointers 53 may correspond to two coordinate points of the present disclosure. The two pointers 53 may be visible for the driver or may be invisible (non-indicative) for the driver. It is assumed that, in the indication screen 51, a horizontal centerline and a vertical centerline exist. In this case, the horizontal centerline extends in the horizontal direction, and the vertical centerline extends in the vertical direction. Further, in this case, the display control unit 120 sets the coordinates of the two pointers 53 on the horizontal centerline in the indication screen 51. Further, in this case, the display control unit 120 sets the coordinates of the two pointers 53 on the horizontal centerline at a position, which corresponds to the middle point in a right region relative to the vertical centerline, and a position, which corresponds to the middle point in a left region relative to the vertical centerline, respectively. Thus, the display control unit 120 sets the coordinates of the two pointers 53 at positions shown by the dashed lines in FIG. 4, respectively.

At step S140, the display control unit 120 determines whether the slide operation in the slide operable region 112b is in an enlarging direction. That is, the display control unit 120 determines whether the slide operation is in the forward direction of the vehicle, i.e., in the upper direction in FIG. 4. On determination that the slide operation is in the enlarging direction, the processing proceeds to step S150. At step S150, the display control unit 120 enlarges the distance between the coordinates of the two pointers 53 according to the amount of the slide operation. Thus, the display control unit 120 enlarges the currently indicated information, such as the map 52, according to an enlargement ratio by which the distance between the two pointers 53 is enlarged.

Alternatively, on determination that the slide operation is in a contracting direction, that is, when the display control unit 120 determines that the slide operation is in the backward direction of the vehicle, i.e., in the lower direction in FIG. 5, the processing proceeds to step S160. At step S160, the display control unit 120 contracts the distance between the coordinates of the two pointers 53 according to the amount of the slide operation. Thus, the display control unit 120 contracts the currently indicated information, such as the map 52, according to a contraction ratio by which the distance between the two pointers 53 is contracted. Step S110 may function as a determination unit. Steps S150 and S160 may function as an indication control unit.

As described above, the input device according to the present embodiment includes the touchpad 112 of the input unit 110 equipped with the slide operable region 112b for exclusive use, in addition to the touch operable region 112a for normal use. Therefore, a driver is enabled to implement the enlarging indication and/or the contracting indication of desired information by the one-finger operation on the slide operable region 112b.

It is noted that, the input device 100 according to the present embodiment is employed in the navigation system 10 for a vehicle. In general, a vehicle causes vibration when traveling. In addition, in such a configuration, a driver is required to operate the input device 100, while looking forward along the traveling direction, without directly viewing the indication screen 51. In consideration of these facts, a driver is hardly enabled, while driving a vehicle, to implement a pinch-out operation and a pinch-in operation with two fingers of one hand by conducting a gesture to enlarge and to contract the distance between the two fingers, respectively, dissimilarly to conventional configurations. That is, a driver is exerted with a big burden when conducting the pinch-out operation and the pinch-in operation to implement the enlarging indication and the contracting indication of an indicated content. In addition, a driver is hardly enabled to implement the pinch-out operation and the pinch-in operation, as intended by the driver. A driver may have a difficulty to move one of two fingers due to, for example, a physical problem. As described above, there are a number of restrictions to enable a driver to implement the gesture, such as the pinch-out operation and the pinch-in operation, on the input device 100 equipped in a vehicle.

To the contrary, the input device 100 according to the present embodiment enables a driver to enlarge and/or contract an indicated content by implementing the slide operation with one finger in the slide operable region 112b. Therefore, even if there are restrictions as descried above, the input device 100 enables a driver easily to operate the input device 100 with less burden. It is noted that, the slide operable region 112b is not limited to accept the slide operation with only one finger. The slide operable region 112b may be configured to accept, for example, a slide operation simultaneously with two or more fingers, which are aligned.

According to the present embodiment, the input device 100 is configured to generate the two pointers 53 in the indication screen 51 in response to contact of a finger in the slide operable region 112b to enlarge or to contract the indicated information. The input device 100 is further configured to enlarge and/or contract the distance between the two pointers 53 according to a slide amount of the finger operation, thereby to implement the enlarging indication and/or the contracting indication of the indicated information, according to the enlargement ratio and/or the contraction ratio at that time. In the present configuration, logic (program) for the enlarging indication and/or the contracting indication can be set easily. Thus, the enlarging indication and/or the contracting indication can be implemented steadily.

According to the present embodiment, it is assumed that the horizontal centerline, which extends in the horizontal direction, and the vertical centerline, which extends in the vertical direction, exist in the indication screen 51. On such an assumption, the input device 100 is configured to generate the coordinates of the two pointers 53 on the horizontal centerline at the middle position in the right region relative to the vertical centerline and at the middle position in the left region relative to the vertical centerline, respectively. With the present configuration, when the two pointers 53 are first generated in the indication screen 51, the positions of the two pointers 53 can be set definitely. In addition, the distance between the two pointers 53 can be enlarged and/or contracted in the indication screen 51, without great difficulty, in the enlarging indication and/or the contracting indication of indicated information.

### Second Embodiment

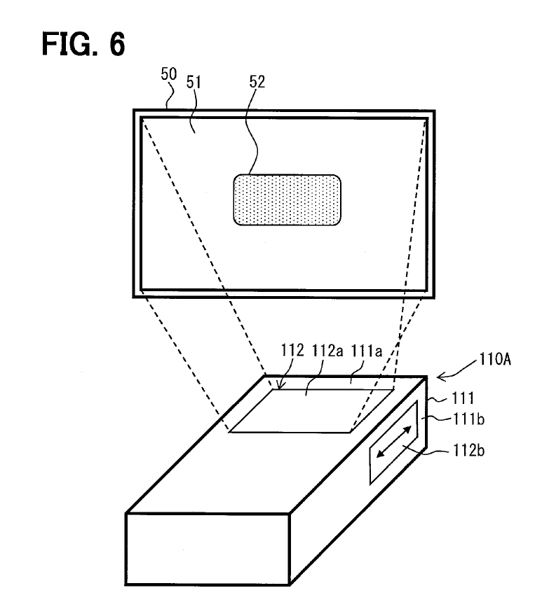

An input unit 110A according to the second embodiment will be described with reference to FIG. 6. In the configuration of the second embodiment, the position of the slide operable region 112b is modified compared with the configuration of the first embodiment. According to the present embodiment, the touch operable region 112a and the slide operable region 112b are distant from each other. More specifically, the slide operable region 112b is formed on a lateral side 111b of the body portion 111.

The present configuration enables a driver to distinguish the touch operable region 112a from the slide operable region 112b and to implement the finger operation. Therefore, a driver is enabled to implement the input operation distinctly and intentionally the operable regions 112a and 112b. Specifically, a driver is enabled to avoid erroneous finger operation in, for example, the touch operable region 112a to implement the enlarging indication and/or the contracting indication wrongly.

In addition, a driver is enabled to implement the input operation with one finger in the slide operable region 112b, as described in the first embodiment, while grabbing the body portion 111 with the other four fingers. Thus, the present configuration enables stable and accurate input operation while the vehicle causes vibration while traveling.

### Third Embodiment

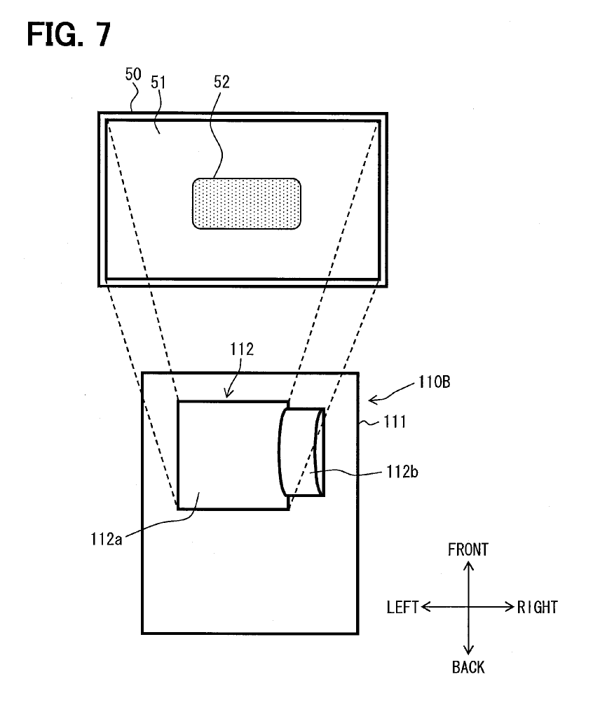

An input unit 110B according to the third embodiment will be described with reference to FIG. 7. In the configuration of the third embodiment, the shape of the slide operable region 112b is modified compared with the configuration of the first embodiment. The slide operable region 112b of the present embodiment is projected from the surface of the touch operable region 112a such that contact sensation of the slide operable region 112b is different from contact sensation of the touch operable region 112a. The slide operable region 112b has an arc-shaped surface extending in a circumferential direction along the front-back direction of the vehicle. The arc-shaped surface of the slide operable region 112b is projected from the body portion 111. The slide operable region 112b has an appearance, which is similar to, for example, a wheel equipped in a mouse for a personal computer.

The slide operable region 112b is located at a position different from the touch operable region 112a. Therefore, the present configuration enables a driver to distinguish the slide operable region 112b from the touch operable region 112a easily with contact sensation of a finger, without visual confirmation.

In addition, the slide operable region 112b of the present embodiment is similar to a wheel of a mouse in shape. Therefore, a driver is enabled to have a feeling like a wheel by sliding a finger on the surface of the slide operable region 112b in the circumference direction of the slide operable region 112b. Thus, a driver is enabled to figure out the operation for the enlarging indication and/of the contracting indication of the indicated information, easily. The present configuration facilitates the input operation, as described above.

In the resent embodiment, the slide operable region 112b may be dented relative to the touch operable region 112a. In this case, the slide operable region 112b has an arc-shaped surface extending in a circumferential direction along the front-back direction of the vehicle. The arc-shaped surface of the slide operable region 112b is dented from the body portion 111. Similarly to the above-described configuration, the present configuration enables a driver to distinguish the slide operable region 112b from the touch operable region 112a easily with contact sensation of a finger, without visual confirmation.

### Other Embodiments

In the above embodiments, the enlarging indication is implemented by sliding a finger in the forward direction, and the contracting indication is implemented by sliding a finger in the backward direction. It is noted that, the sliding directions of a finger for the enlarging indication and the contracting indication are not limited to those in the above-described embodiments. The sliding direction for the enlarging indication may be set arbitrarily in a direction relative to the slide operable region 112b, and the sliding direction for the contracting indication may be set arbitrarily in a direction different from the direction for the enlarging direction. In a configuration where the sliding direction for the enlarging indication is opposite to the sliding direction for the contracting indication, the sliding operations can be easily understood by a driver.

In the above embodiments, the coordinates of the two pointers 53 for the enlarging operation and the contracting operation are set on the horizontal centerline at the middle position in the right region relative to the vertical centerline and at the middle position in the left region relative to the vertical centerline, respectively. It is noted that the coordinates of the two pointers 53 are not limited to those in the above-described embodiments. The coordinates of the two pointers 53 may be arbitrarily set at positions to enable enlarging and contracting the distance between the two pointers 53 for the enlarging operation and the contracting operation appropriately.

In the second embodiment, the slide operable region 112b is formed on the lateral side 111b of the body portion 111 and thereby located at the distant position from the touch operable region 112a. It is noted that, the location of the slide operable region 112b is not limited to that of the second embodiment. The slide operable region 112b may be formed on the upper surface 111a of the body portion 111 and may be located at a distant position from the touch operable region 112a. In this way, the slide operable region 112b may be located away from the touch operable region 112a.

In the third embodiment, the slide operable region 112b may be located on the upper surface 111a of the body portion 111 at a distant position from the touch operable region 112a, such that the slide operable region 112b is located away from the touch operable region 112a. Alternatively, the slide operable region 112b may be located on the lateral side 111b.

In the above embodiments, the input device 100 is employed in the navigation system 10 for a vehicle to operate the multifunctional portable device 60, the audio device 70, the airconditioner 80, and the like. The application of the input device 100 is not limited to the above-described application. The input device 100 may be employed in a remote controller for operating a function of an appliance such as an internet television for home use.

As described above, the present disclosure employs the following configurations.

The input unit may be a separate component from the display unit and may be configured to accept the input operation with a finger of a user for indicating desired information on the display unit according to the input operation. The input unit may include the first operable region and the second operable region, which are partitioned from each other. The first operable region may be configured to enable the input operation with the finger. The second operable region may be configured to enable the input operation with the finger different from the finger related to the first operable region. The input device may further include the display control unit configured to modify an indicated content of the desired information corresponding to the input operation with the finger on the first operable region and the input operation with the finger on the second operable region.

The present configuration enables the input operation with the specific finger on one of the first operable region and the second operable region. In addition, the present configuration further enables the input operation with the finger, which is different from the specific finger, on the other of the first operable region and the second operable region, when the input operation with the specific finger is restricted. Therefore, in a case where the input operation with two fingers, such as the pinch-in operation and/or the pinch-out operation, cannot be implemented in one of the operable regions, the present configuration enables the input operation in the other operable region, without requiring such an input operation with two fingers. Thus, operability of the input device can be enhanced.

The first operable region and the second operable region may be formed at locations distant from each other.

The present configuration enables a user to implement the input operation with a finger distinctively between the first operable region and the second operable region. Therefore, a user is enabled to implement the input operation intentionally while recognizing the operable region.

The surface of one of the first operable region and the second operable region may be projected or dented relative to the surface of the other of the first operable region and the second operable region, such that a touch contact sensation on the first operable region and a touch contact sensation on the second operable region are different from each other.

The present configuration enables a user to recognize one of the operable regions, on which the user is currently operating, easily with the contact sensation of the finger, without visual confirmation.

The display control unit may be further configured to implement the enlarging indication of the desired information, when the finger is slid on the second operable region in the predetermined direction. In this case, the display control unit may be further configured to implement the contracting indication of the desired information, when the finger is slid on the second operable region in a direction different from the predetermined direction. The display control unit may be further configured to generate the two coordinate points in the display unit in response to contact for sliding the finger on the second operable region. The display control unit may be further configured to enlarge or contract the distance between the two coordinate points according to the amount by which the finger slides for the input operation. The display control unit may be further configured to implement the enlarging indication or the contracting indication of the desired information according to the enlargement ratio or the contraction ratio at that time.

The present configuration enables to set logic (program) for the enlarging indication and/or the contracting indication easily. Therefore, the enlarging indication and/or the contracting indication can be steadily implemented.

The display control unit may be further configured, on assumption that the horizontal centerline, which extends in the horizontal direction, and the vertical centerline, which extends in the vertical direction, exist in the display unit, to generate the two coordinate points on the horizontal centerline at the middle position in the right region relative to the vertical centerline and at the middle position in the left region relative to the vertical centerline, respectively.

The present configuration enables to set the positions of the two coordinate points definitely, when the two coordinate points are first generated in the display unit. In addition, the distance between the two coordinate points can be enlarged and/or contracted in the display unit, without great difficulty, in the enlarging indication and/or the contracting indication of the desired information.

The input device may further include the body portion. In this case, the first operable region may be located on the front side of the body portion, and the second operable region may be located on the lateral side of the body portion. The present configuration enables a user to recognize the second operable region distinctively from the first operable region easily.

The display control unit may be further configured to generate the two coordinate points as visible points. With the present configuration, a user can easily recognize the two coordinate points in the display unit.

Alternatively, the display control unit may be further configured to generate the two coordinate points as invisible points. The present configuration enables the two coordinate points not to disturb visibility of indication on the display unit.

The input device may be for manipulating indication of information on the display unit and may include the input unit being a separate component from the display unit. In this case, the input unit may include the first operable region and the second operable region, which are partitioned from each other. The first operable region may be configured to accept an input operation with the first finger of a user, and the second operable region may be configured to accept an input operation with the second finger different from the first finger. In this case, the determination unit may be configured to determine whether the first operable region accepts an input operation and to determine whether the second operable region accepts an input operation. In this case, the indication control unit may be configured to modify indication of information in the first mode, when the determination unit determines that the first operable region accepts an input operation, and to modify indication of information in the second mode, which is different from the first mode, when the determination unit determines that the second operable region accepts an input operation. The present configuration enables a user to operate the input device with the second finger in the second operable region when the user is restricted from operating with the first finger in the first operable region.

The indication control unit may be further configured to move indication of information in the first mode when the determination unit determines that the first operable region accepts an input operation. In this case, the indication control unit may be further configured to enlarge indication of information in the second mode when the determination unit determines that the second operable region accepts an input operation sliding in the first direction. In this case, the indication control unit may be further configured to contract indication of information in the second mode when the determination unit determines that the second operable region accepts an input operation sliding in the second direction different from the first direction. The present configuration enables a user to implement different operation in the first mode and the second mode, respectively, with the first finger in the first operable region and with the second finger in the second operable region.

The first operable region may be further configured to accept an input operation with the third finger, which is different from both the first finger and the second finger. In this case, the indication control unit may be further configured to modify indication of information according to an input operation with both the first finger and the third finger in the first operable region. The present configuration enables a user to implement an input operation in the first operable region with both the first finger and the third finger in various ways.

The first operable region may be further configured to accept the pinch-out operation implemented by enlarging the distance between the first finger and the third finger and to accept the pinch-in operation implemented by contracting the distance between the first finger and the third finger. In this case, the second operable region may be further configured to accept the sliding operation with the second finger in the first direction and to accept the sliding operation with the second finger in the second direction different from the first direction. In this case, the indication control unit may be further configured to enlarge indication of information in response to at least one of the pinch-out operation and the sliding operation in the first direction and to contract indication of information in response to at least one of the pinch-in operation and the sliding operation in the second direction. The present configuration enables a user to implement an input operation with the first finger, the second finger, and the third finger in various ways.

The indication control unit may be further configured to enlarge indication of information in response to the pinch-out operation simultaneously with the sliding operation in the first direction and to contract indication of information in response to the pinch-in operation simultaneously with the sliding operation in the second direction. The present configuration enables a user to implement the combination of the pinch-out operation and the sliding operation in the first direction and the combination of the pinch-in operation and the sliding operation in the second direction, thereby to allow various input operations.

Alternatively, the indication control unit may be further configured to enlarge indication of information in response to one of the pinch-out operation and the sliding operation in the first direction and to contract indication of information in response to one of the pinch-in operation and the sliding operation in the second direction. That is, the indication control unit may accept either an input operation in the first operable region or an input operation in the second operable region exclusively at the same time. The present configuration restricts a user not to implement a wrong input operation caused by simultaneous combination of an input operation in the first operable region and an input operation in the second operable region, thereby to allow various input operations.

The first finger may be the fore finger of a user, the second finger may be the thumb, and the third finger may be one of fingers other than the fore finger and the thumb.

The first finger may be one of the fore finger and the middle finger of a user, the second finger may be the other of the fore finger and the middle finger, and the third finger may be one of fingers other than the fore finger and the middle finger.

The above structures of the embodiments can be combined as appropriate. The above processings such as calculations and determinations are not limited being executed by the display control unit 120. The control unit may have various structures including the display control unit 120 shown as an example.

The above processings such as calculations and determinations may be performed by any one or any combinations of software, an electric circuit, a mechanical device, and the like. The software may be stored in a storage medium, and may be transmitted via a transmission device such as a network device. The electric circuit may be an integrated circuit, and may be a discrete circuit such as a hardware logic configured with electric or electronic elements or the like. The elements producing the above processings may be discrete elements and may be partially or entirely integrated.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. An input device configured to be operated by a user and to be used with a display unit, comprising:
an input unit being a separate component from the display unit, the input unit being configured to accept an input operation with a finger of the user for manipulating information indicated on the display unit, the input unit including a first operable region and a second operable region, which are partitioned from each other, the first operable region being configured to accept an input operation with a first finger, the second operable region being configured to accept an input operation with a second finger, which is different from the first finger; and
a display control unit configured to modify indication of information correspondingly to an input operation with the first finger in the first operable region and an input operation with the second finger in the second operable region.

2. The input device according to claim 1, wherein the first operable region and the second operable region are distant from each other.

3. The input device according to claim 1, wherein a surface of one of the first operable region and the second operable region is projected or dented relative to a surface of an other of the first operable region and the second operable region, such that a touch contact sensation in the first operable region is different from a touch contact sensation in the second operable region.

4. The input device according to claim 1, wherein
the display control unit is further configured
to enlarge indication of information when the second finger is slid in the second operable region in a first direction, and
to contract indication of information when the second finger is slid in the second operable region in a second direction, which is different from the first direction,
to generate two coordinate points in the display unit in response to contact for sliding the second finger in the second operable region,
to enlarge or contract a distance between the two coordinate points according to an amount by which the second finger slides for the input operation, and
to enlarge or contract indication of information according to an enlargement ratio of the distance or a contraction ratio of the distance.

5. The input device according to claim 4, wherein
the display unit has a horizontal centerline and a vertical centerline,
the horizontal centerline extends in a horizontal direction,
the vertical centerline extends in a vertical direction, and
the display control unit is further configured
to generate one of the two coordinate points on the horizontal centerline at a middle position in a right region relative to the vertical centerline in the display unit and
to generate an other of the two coordinate points on the horizontal centerline at a middle position in a left region relative to the vertical centerline in the display unit.

6. The input device according to claim 2, further comprising
a body portion, wherein
the first operable region is located on a front side of the body portion, and
the second operable region is located on a lateral side of the body portion.

7. The input device according to claim 5, wherein the display control unit is further configured to generate the two coordinate points as visible points.

8. The input device according to claim 5, wherein the display control unit is further configured to generate the two coordinate points as invisible points.

9. An input device for manipulating indication of information on a display unit, the input device comprising:
an input unit being a separate component from the display unit, the input unit including a first operable region and a second operable region, which are partitioned from each other, the first operable region being configured to accept an input operation with at least one of a first finger and a second finger of a user, the second operable region being configured to accept an input operation with one of the first finger and the second finger;
a determination unit configured
to determine whether the first operable region accepts an input operation and
to determine whether the second operable region accepts an input operation; and
an indication control unit configured
to modify indication of information in a first mode when the determination unit determines that the first operable region accepts an input operation and
to modify indication of information in a second mode, which is different from the first mode, when the determination unit determines that the second operable region accepts an input operation.

10. The input device according to claim 9, wherein
the indication control unit is further configured
to move indication of information in the first mode when the determination unit determines that the first operable region accepts an input operation
to enlarge indication of information in the second mode when the determination unit determines that the second operable region accepts an input operation sliding in a first direction and
to contract indication of information in the second mode when the determination unit determines that the second operable region accepts an input operation sliding in a second direction, which is different from the first direction.

11. The input device according to claim 9, wherein
the first operable region is further configured to accept an input operation with a third finger, which is different from both the first finger and the second finger, and
the indication control unit is further configured to modify indication of information according to an input operation with both the first finger and the third finger in the first operable region.

12. The input device according to claim 11, wherein
the first operable region is further configured
to accept a pinch-out operation implemented by enlarging a distance between the first finger and the third finger and
to accept a pinch-in operation implemented by contracting the distance between the first finger and the third finger,
the second operable region is further configured
to accept a sliding operation with the second finger in a first direction and to accept a sliding operation with the second finger in a second direction, which is different from the first direction, and
the indication control unit is further configured
to enlarge indication of information in response to at least one of the pinch-out operation and the sliding operation in the first direction and
to contract indication of information in response to at least one of the pinch-in operation and the sliding operation in the second direction.

13. The input device according to claim 12, wherein
the indication control unit is further configured
to enlarge indication of information in response to the pinch-out operation simultaneously with the sliding operation in the first direction and
to contract indication of information in response to the pinch-in operation simultaneously with the sliding operation in the second direction.

14. The input device according to claim 12, wherein
the indication control unit is further configured
to enlarge indication of information in response to one of the pinch-out operation and the sliding operation in the first direction and
to contract indication of information in response to one of the pinch-in operation and the sliding operation in the second direction.

15. The input device according to claim 11, wherein
the first finger is a fore finger,
the second finger is a thumb, and
the third finger is one of fingers other than the fore finger and the thumb.

16. The input device according to claim 11, wherein
the first finger is one of a fore finger and a middle finger,
the second finger is an other of the fore finger and the middle finger, and the third finger is one of fingers other than the fore finger and the middle finger.

17. The input device according to claim 9, wherein
the first operable region is further configured
to accept a pinch-out operation implemented by enlarging a distance between the first finger and the second finger and
to accept a pinch-in operation implemented by contracting the distance between the first finger and the second finger,
the second operable region is further configured
to accept a sliding operation with the one of the first finger and the second finger in a first direction and
to accept a sliding operation with the one of the first finger and the second finger in a second direction, which is different from the first direction, and
the indication control unit is further configured
to enlarge indication of information in response to at least one of the pinch-out operation and the sliding operation in the first direction and
to contract indication of information in response to at least one of the pinch-in operation and the sliding operation in the second direction.

18. An input device for manipulating indication of information on a display unit, the input device comprising:
an input unit being a separate component from the display unit, the input unit including a first operable region and a second operable region, which are partitioned from each other, the first operable region being configured to accept an input operation with both a first finger and a second finger of a user, the second operable region being configured to accept an input operation with one of the first finger and the second finger;
a determination unit configured
to determine whether the first operable region accepts an input operation and
to determine whether the second operable region accepts an input operation; and
an indication control unit configured
to modify indication of information in a first mode when the determination unit determines that the first operable region accepts an input operation and
to modify indication of information in a second mode, which is different from the first mode, when the determination unit determines that the second operable region accepts an input operation.
